(19) United States
(12) Patent Application Publication
(10) Pub. No.: US 2022/0120412 A1
(43) Pub. Date: Apr. 21, 2022

(54) LIGHTING FIXTURE

(71) Applicant: ERCO GmbH, Lüdenscheid (DE)

(72) Inventor: Matthias BREMERICH, Lennestadt (DE)

(21) Appl. No.: 17/500,172

(22) Filed: Oct. 13, 2021

(30) Foreign Application Priority Data
Oct. 19, 2020 (DE) 10 2020 127 476.9

(51) Int. Cl. F21V 7/09; F21V 13/04; F21V 7/06; F21V 5/04; G02B 27/30

(52) U.S. Cl. CPC F21V 7/09; F21V 13/04; F21S 8/06; F21V 5/048; G02B 27/30; F21V 7/06

(57) ABSTRACT

A luminaire for illuminating building spaces or building part-spaces, including a light source, which has at least one LED, as well as a collimator optics and a reflector, wherein a radially inner light fraction emitted by the light source hits the collimator optics and is focused thereby, and wherein a radially outer light fraction emitted by the light source bypasses the collimator optics, hits the reflector and is focused thereby.

The invention relates to a luminaire according to claim 1.

The applicant has been developing and manufacturing luminaires for decades. The known luminaires are used to illuminate a space in a building or a part-space in a building, for example a wall area or floor area of a building or an exterior area associated with a building, e.g. a path area. Said building part-spaces should also be understood as being, for example, pieces of art, such as paintings or statues, that are likewise arranged in a building or associated with a building of this kind.

With the fundamental changeover from the lamps used in luminaires of this kind to the operation of LEDs, and particularly also with the supply-voltage change from the conventional 120/230 V AC to supply voltages of between 20 and 50 V that is occurring alongside the lamp changeover, the design and construction of luminaires is also changing.

DE 10 2008 063 369 A1 discloses a luminaire in which a lens plate having a plurality of microstructures is replaceably arranged. By replacing the lens plate, the light distribution of the luminaire can be altered.

Starting from the luminaire disclosed in the patent application described at the outset, there is a fundamental desire to provide a luminaire that can be assembled in a modular manner, makes it possible to alter the light distribution using simple means and generates a high-quality light distribution while having very high efficiency.

A luminaire of this type that meets these requirements is described in the post-published German patent application DE 10 2019 119 682 A1 belonging to the applicant.

In this document, the luminaire is to be equipped with a single lens element. The above-described luminaire has a light drive that provides a parallel pencil of light. A collimator optics is provided for this purpose.

With average and large to very large overall dimensions in particular, manufacturing equally large-scale collimator optics poses manufacturing problems.

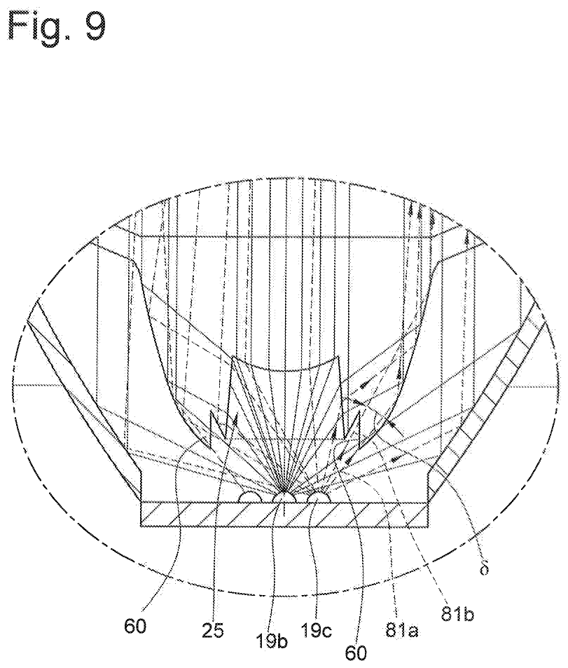

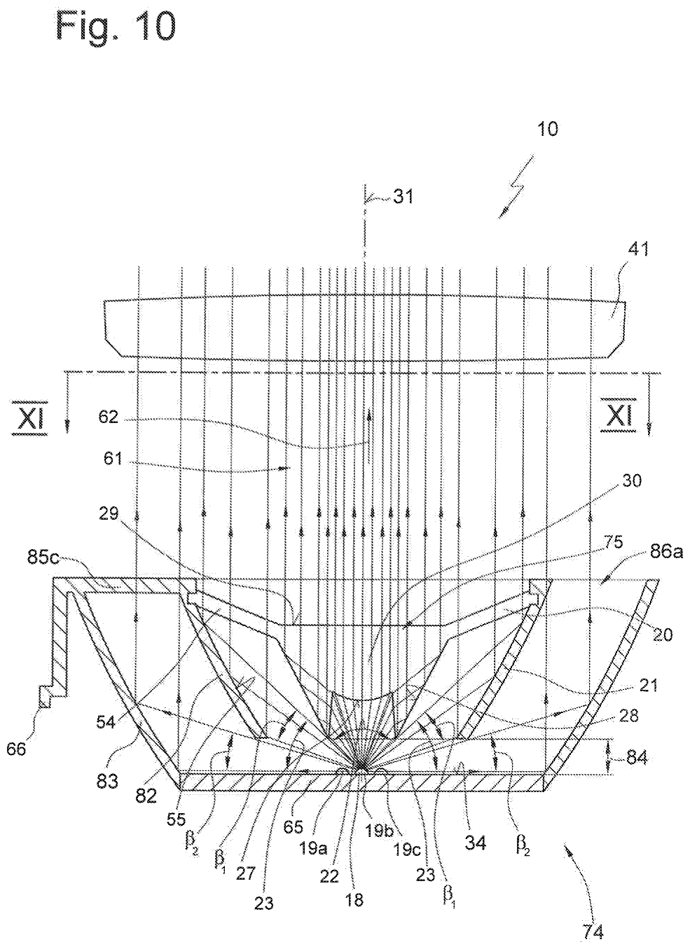

Against this background, the post-published patent application referred to above proposes, in its embodiment examples according to FIGS. 9 and 10, collimator optics that are in the form of a Fresnel lens and have a small installation height so as to thus enable simpler manufacture.

However, undesirable effects may be produced in the light distribution under certain conditions, including depending on the light sources used, and partly also as a result of resonance effects and multiple reflections. The manufacture of these collimator optics is also subject to particular requirements.

On this basis, the object of the present invention is to provide a luminaire that uses a light drive that is universally usable for different light sources and which, in particular, is simple to scale up in size and, in particular, allows for very simple production even when the luminaires to be manufactured have very large dimensions.

This object is achieved by the invention with the features of claim 1.

The principle of the invention is substantially to additionally provide a reflector for focusing the light beams instead of a collimator optics as is known in the prior art.

The special feature is that the collimator optics is arranged on the optical axis of the light source and the radial pencil of light emitted by the light source is collimated or focused, in particular into a parallel pencil of light or a substantially parallel pencil of light. In the process, the collimator optics is arranged such that a radially outer light fraction emitted by the light source is radiated past the collimator optics, i.e. bypasses the collimator optics. This bypassing incident light hits a reflector and is focused thereby.

The pencil of light reflected by the reflector likewise exits the light drive as a parallel pencil of light. Preferably, the light source is arranged in the region of the focal point of the reflector, which is parabolic.

According to the invention, therefore, a luminaire having a collimating light drive is provided, said light drive focusing the light emitted by the light source in a special way: Focusing is achieved by both the central collimator optics, which is arranged close to the optical axis, and a reflector arranged radially outwards. In the process, each of these two collimating elements performs its own task.

The wording whereby a radially outer light fraction emitted by the light source bypasses the collimator optics includes embodiments in which said radially outer light fraction also bypasses the total-reflection surfaces on the collimator optics and/or the refractive optical boundary surfaces on the collimator optics.

However, the wording does not exclude the possibility that material regions are additionally arranged on the collimator optics and, for example, are still penetrated by the light fractions that reach the reflector from the light source.

In particular, however, this wording includes all variants in which the collimator optics has a light entry surface through which the light fractions emitted radially on the inside by the light source enter the collimator optics and, in the process, are conducted onto total-reflection surfaces and/or hit refractive boundary surfaces, the light fractions emitted radially on the outside by the light source being cast past said light entry surface of the collimator optics and hitting the reflector directly.

Preferably, the collimator optics comprises a cavity having sides and a top portion. The top portion is arranged centrally on the optical axis and provides a lens portion. The sides of the cavity are for the entry of light-beam fractions that are deflected onto a total-reflection surface of the collimator optics, from where they reach the light exit surface of the collimator optics.

The collimator optics is arranged at a distance from the light source.

Whereas in the prior art a cavity of a collimator optics was used to receive the LEDs, meaning that this cavity could overlap the LEDs, according to the invention the collimator optics is deliberately arranged at a distance from the light source so as to provide space that allows radially outer light fractions to bypass.

The collimator optics is positioned precisely in relation to the reflector. Advantageously, the collimator optics and reflector are fastened to one another. The reflector can be fastened either directly or indirectly in relation to the collimator optics. The invention also covers the configuration in which the collimator optics and reflector are fastened to one another by means of an installation element, e.g. by means of a clamping ring.

Advantageously, the collimator optics and reflector together also form a handling unit that can be installed and/or fastened and/or positioned jointly on a housing of the luminaire and/or in relation to a housing of the luminaire.

The luminaire according to the invention comprises a light source comprising one or more LEDs. Possible LEDs are, in particular, high-power LEDs or chip-on-board (COB) LEDs. The LEDs can all have the same color or have different light colors, or also be color-changeable.

The invention also covers luminaires that provide a light-mixing unit as a light source.

A light-mixing unit of this kind can, for example, have one or more LEDs or a plurality of LED pixels, the different LEDs or the different LED pixels being able to emit light of the same color or of different colors. For instance, a light-mixing unit can comprise an RGBW LED light source having a red, green, blue and white LED, or a plurality of LEDs that emit light of different shades of white (tunable white). The light-mixing unit can mix the light emitted by different light sources. For this purpose, the light-mixing unit can also have a reflector, for example. In this case, therefore, a light source having a complex structure provides light that is blended, in particular pre-blended, in terms of color and/or homogeneously.

The luminaire according to the invention is used to illuminate building spaces or building part-spaces. These can include in particular floor areas, wall areas or ceiling areas of a building, pieces of art such as statues or paintings, and also path areas or traffic areas, in particular in both the interior and exterior of buildings.

The luminaire can, for example, be installed on the ceiling or on a base wall or a side wall of the building, or be in the form of a column luminaire or bollard luminaire. An embodiment example of the invention in which the luminaire is in the form of a lamp that can in particular be installed on a luminaire track is particularly advantageous.

A collimator optics within the meaning of the present patent application is an element that focuses light and consists of a transparent material, e.g. of PMMA, glass or silicone. In particular, the collimator optics is arranged on the optical axis of the light source. The collimator optics is designed to focus a radially inner light fraction emitted by the light source. In particular, the collimator optics can emit a parallel or substantially parallel pencil of light from the light exit surface of the collimator optics.

The collimator optics can in particular have a cavity. More particularly, the cavity in the collimator optics provides the light entry surface of the collimator optics. The cavity can have a top surface and side-wall portions.

Advantageously, in a direction transverse to an optical axis of the collimator optics, the cavity can have a dimension that exceeds a dimension of the light source. This ensures that the collimator optics of a particular size can be used for different types of light sources, in particular for light sources having different numbers of LEDs or having different dimensions.

According to an advantageous embodiment of the invention, the collimator optics is arranged at a distance from the light source. The distance is also referred to as a bypassing distance. This term indicates that the distance from the collimator optics serves to permit a bypassing beam fraction such that light fractions emitted by the light source can bypass the collimator optics in order to directly reach the reflector.

In particular, the radially outer light fraction bypasses the collimator optics in its entirety, i.e. it does not penetrate the collimator optics and is not refracted thereby.

In the context of the invention, it is made clear that the bypassing distance serves in particular to ensure that the radially outer light fraction can bypass the refractive side-wall portions of the cavity in order to reach the reflector.

The collimator optics is arranged at a distance from the light source along the optical axis of collimator optics.

The light source in the form of an LED generally emits light within a 180° spatial range in accordance with a Lambertian distribution. In general, the optical axis corresponds to a normal vector to the arrangement plane of the LEDs, which can be provided, for example, by a printed circuit board.

The reflector is, for example, a plastics injection-molded part that is in particular coated, on its inner face, with metal, e.g. silver, in order to obtain a highly reflective reflection surface. In particular, the reflection surface of the reflector is highly metallized. Advantageously, the reflector is parabolic or substantially parabolic. The light source is advantageously arranged in the focal point of the reflector.

It is also advantageous to design the reflector such that it extends, by its portion facing the light source, as far as to an arrangement plane of the light source, or as far as to the vicinity of said arrangement. As a result, a maximum amount of light emitted by the light source can be captured and the luminaire can be designed efficiently.

According to another advantageous embodiment of the invention, the reflector extends as far as to the vicinity of an inner wall of a housing of the luminaire. What is obtained as a result is a luminaire that has a very large aperture, which enables a very narrow-angled light distribution.

According to another advantageous embodiment of the invention, the reflector has an axial installation height that exceeds an axial installation height of the total-reflection surfaces of the collimator optics. The axial installation height relates to a direction of the optical axis of the collimator optics.

The collimator optics advantageously has total-reflection surfaces. It is also advantageous for the collimator optics to have a lens portion, which collimates a central light beam, and total-reflection surfaces, which collimate a light beam that surrounds the central light beam. The total-reflection surfaces of the collimator optics extend in a shell-shaped manner around a middle region of the collimator optics.

According to this advantageous embodiment of the invention, the reflector can have an axial installation height that is considerably larger than the axial installation height of the total-reflection surface of the collimator optics.

This makes it possible to produce a reflector in a simple manner using conventional manufacturing techniques but to equip the collimator optics with only a very small installation height, thereby simplifying production of the collimator optics.

According to a particularly advantageous embodiment of the invention, the collimator optics has a maximum external diameter that is greater than 30 mm, in particular greater than 35 mm, more particularly greater than 40 mm, more particularly greater than 45 mm, more particularly greater than 50 mm, more particularly greater than 55 mm, more particularly greater than 60 mm, more particularly greater than 70 mm, more particularly greater than 80 mm, more particularly greater than 90 mm, more particularly greater than 100 mm.

In this variant of the invention, it is possible to produce a very large collimator optics for large luminaires having an accordingly high luminous power while the collimator optics itself only has to have a very small axial installation height.

According to another advantageous embodiment of the invention, the luminaire has a rotationally symmetrical light distribution. According to an alternative embodiment of the invention, the collimator optics has a non-rotationally symmetrical light distribution.

According to an advantageous embodiment of the invention, the collimator optics is fastened to the reflector. For this purpose, the reflector can comprise retaining surfaces that interact with corresponding mating retaining surfaces on the collimator optics.

The collimator optics can be fastened to the reflector using, for example, spring-lock elements or snap-in elements.

By way of example, the collimator optics can be secured on the reflector in the axial direction. As another alternative, the reflector can also consist of a plurality of parts, e.g. two shell parts, that can be fastened, e.g. clippably fastened, to one another and can clip and/or hold the collimator optics between them.

Particularly advantageously, the collimator optics is secured to the reflector in a relative manner such as to provide a handling unit. The handling unit can be secured jointly on a housing of the luminaire, either indirectly or directly on the housing.

It is essential that the collimator optics and the reflector assume a defined fixed position relative to one another.

According to another advantageous embodiment of the invention, the collimator optics has a positioning flange. This allows for a sophisticated and simple construction to secure the collimator optics on the reflector and does not impair the manufacture of even large collimator optics.

According to another advantageous embodiment of the invention, the collimator optics extends, by the positioning flange, as far as to the vicinity of an inner wall of the reflector. In particular, the positioning flange extends as far as to the vicinity of an inner wall of the reflector in the region of its free end portion that is at a maximum distance from the light source.

This enables a particularly simple construction.

According to another advantageous embodiment of the invention, the radially outer light fraction passes through the positioning flange after being reflected on the reflector. This enables a particularly simple construction.

The positioning flange can be annulus-shaped and surround the center portion or core portion of the collimator optics in an annular manner. The invention also covers a configuration in which the positioning flange is formed by individual or a plurality of ribs.

According to another advantageous embodiment of the invention, the reflector is fastened to a housing of the luminaire. This enables a particularly simple construction and design of the luminaire according to the invention.

According to another advantageous embodiment of the invention, the luminaire has a lens element downstream of the collimator optics in the light path. Said lens element can alter the light distribution, e.g. enlarge the beam angle. Whereas the actual light drive, which comprises the light source, the collimator optics and the reflector, generates a parallel or substantially parallel pencil of light and makes it available for further manipulation by the downstream lens element, the lens element can influence, for example shape, the light distribution or the beam shape, expand the beam or, for example, also generate an oval light distribution. For this purpose, the lens element can, for example, be in the form of a convergent lens or a divergent lens.

By way of example, the lens element can have a concavely curved light entry surface and a planar or slightly convexly curved light exit surface.

The invention also covers a configuration in which the lens element arranged downstream of the collimator optics is designed according to the type of lens plate, and, for example, has a plurality of small lens elements or micro-lens elements.

In this respect, reference is made, by way of example, to lens plates as disclosed and described in numerous different variants in the German patent application DE 10 2008 063 369 A1 belonging to the applicant.

To avoid repetitions, the content of that patent application is hereby included in full in the content of the present patent application, so as to also include features of that patent application in the claims of the present patent application as necessary.

According to another advantageous embodiment of the invention, the lens element can extend as far as to an inner wall of a housing of the luminaire. It is also advantageous in this context for the lens element to be in the form of a single lens element.

Furthermore, the luminaire can advantageously have a circular-cylindrical or substantially circular-cylindrical housing. This enables a particularly simple construction of the luminaire according to the invention.

According to another advantageous embodiment of the invention, the collimator optics comprises a collar-like portion that extends in a direction towards an arrangement plane of the light source. In particular, the collar-like portion can be provided so as to prevent light fractions emitted by the light source from reaching an inner wall of the housing without having previously been reflected by a reflector or without having previously passed through the collimator optics and in particular been deflected. When using large or expanded light sources in particular, at certain proportions there exist light fractions that, without the use of a collar-like portion of this kind, can in some circumstances bypass the collimator optics but not hit the reflector, instead directly reaching inner-wall portions of the housing. This may result in glare effects, which are undesirable in this respect, for example high light distributions that are concentrated at points on the inner wall of the housing. The collar-like portion can prevent light fractions of this kind from directly hitting the inner-wall portions of the housing of the luminaire.

Furthermore, the collar-like portion can advantageously be formed by a portion of a Fresnel lens.

According to another advantageous embodiment of the invention, the light fraction exiting through a light exit surface of the collimator optics, i.e. the light that has been focused by the collimator optics and the light that has been focused by the reflector, can provide a parallel or substantially parallel pencil of light. This enables particularly simple further manipulation of this light by elements arranged downstream in the light path, such as diffusers or divergent lenses.

According to another advantageous embodiment of the invention, a diffuser is arranged downstream of the collimator optics in the light path. Said diffuser can be used to provide homogenization and blending of the light.

According to a further aspect, the invention relates to a system for providing building luminaires according to claim 27.

The object of the invention is to provide a system by which it is possible to alter the light distribution of the luminaire using simple means, or that enables use of a number of identical parts and/or the provision of a modular system.

The invention achieves this object with the features of claim 27.

To avoid repetitions, reference is made to the above explanations, which apply analogously to the invention according to claim 27.

The principle of the invention is that a first luminaire and a second luminaire that match or substantially match the above-described luminaire are provided.

In the process, the first luminaire has a first lens element and the second luminaire has a second lens element. The two lens elements are formed differently and make it possible to generate different light distributions. For example, a first lens element can provide a light distribution having a first beam angle, and a second lens element can provide a light distribution having a second beam angle different from the first beam angle. The different beam angles can be achieved by forming the boundary surfaces of the lens elements, in particular of the divergent lenses, differently.

The invention also covers a configuration in which the first lens element generates a rotationally symmetrical light distribution and the second lens element generates a non-rotationally symmetrical light distribution.

The luminaire according to the invention can be equipped with a single lens element. The luminaire can have a cylindrical housing, for example a circular-cylindrical housing. The single lens element can have a circular-cylindrical outer circumferential surface and extend, by its external diameter, as far as to the inner circumferential surface of the housing.

The single lens element can have a concavely curved light entry surface and a planar or slightly convexly curved light exit surface. The entry surface can be cylindrically curved, or curved so as to be doubly concave, i.e. spherically or approximately spherically.

In particular, the single lens element has a concave light entry surface that extends from the edge region on one side of the housing as far as to the edge region of the housing 180° opposite thereto. In particular, the lens element can capture all the light emitted by the collimator optics.

The greater the concave curvature of the light entry surface of the lens element, the stronger the scattering effect. Therefore, by using different lens elements having light entry surfaces of different curvatures, different beam angles of the luminaire can be obtained. By way of example, a spotlight distribution, flood light distribution, wide flood light distribution or oval light distribution can be generated by replacing a lens element.

The luminaire can have a housing that has a housing portion carrying the lens element. The housing portion can be formed so as to be removable, for example unclippable or unscrewable, from the other housing parts. The lens element can be overlapped by or overlaid with portions of the housing and thus be retained on the housing of the luminaire.

Since the luminaire according to the invention advantageously has just one lens element, the so-called “single” lens element, it is possible to avoid undesirable scattered light fractions using very simple means:

Specifically, according to the invention it is possible in particular for the outer circumferential surface of the lens element to be darkened. This prevents total reflections entirely in this region, and scattered light fractions, which would otherwise be unavoidable, are prevented in their entirety.

The luminaire according to the invention thus makes it possible to achieve a light distribution in which the undesirable scattered light effects are eliminated, as known similarly from other luminaires by the term “darklight” in reflector technology.

According to the invention, a luminaire that can have a very large lens element is provided. Said lens element can have an external diameter that is as large or almost as large as the internal circumferential diameter of the housing. As a result, the lens element can have an extension that corresponds or almost corresponds to the extension of the light exit surface of the collimator optics. In particular, therefore, the light can be manipulated efficiently within the luminaire.

Owing to the planar or substantially planar, or at most slightly rounded, light exit surface of the lens element, the same shape, or a similar outer shape of the luminaire, and thus homogeneous visual characteristics, can also be achieved for different lens elements and lens element light entry surfaces of different curvatures. From the outside of the luminaire, therefore, it cannot be discerned, or at least cannot always be discerned, which type of lens element is installed. As a result, luminaires that have the same or a very similar external appearance and generate different light distributions can be used. If, for example, a plurality of luminaires having different light distributions are installed next to one another, it is thus possible to achieve different light distributions of the individual luminaires, without using luminaires having different external appearances.

The collimator optics of the luminaire according to the invention has a cavity in particular at the inlet. The cavity can be provided by a top wall and by a side wall. The top wall can be planar or convexly curved and can form, together with an opposite central portion arranged on the light-exit side of the collimator optics, a convergent lens, in particular a biconvex convergent lens.

The side-wall portions of the cavity are surrounded by a total-reflection surface. The total-reflection surface can provide the outer side wall of the collimator optics and, for example, substantially form a shell shape.

According to another advantageous embodiment of the invention, the lens element can be releasably secured on the housing. As a result, simple handling of a replaceability of the lens element can be achieved to obtain a different light distribution of the luminaire.

According to another advantageous embodiment of the invention, the lens element is formed so as to be replaceable. This provides a luminaire that makes it possible to generate a different light distribution by simply replacing a lens element.

According to another advantageous embodiment of the invention, the lens element is rotationally symmetrical. This makes it possible to provide a spotlight distribution, flood light distribution or wide flood light distribution.

In particular, a first lens element can be rotationally symmetrical and a second lens element can also be rotationally symmetrical. When in their installed state on the luminaire, the two lens elements can generate different light distributions, e.g. different beam angles. By way of example, a first narrow light distribution, e.g. a spotlight distribution, can be generated using a first lens element, and a wider light distribution, e.g. a flood light or wide flood light distribution, having an accordingly larger beam angle, can be generated using a second lens element in the installed state.

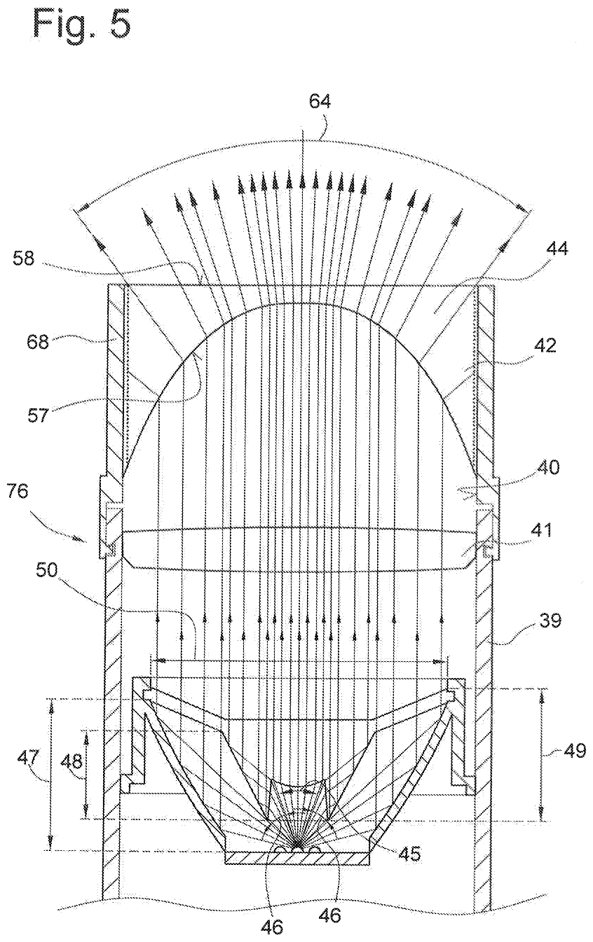

According to another advantageous embodiment of the invention, the lens element is non-rotationally symmetrical and provides an oval light distribution. The non-rotationally symmetrical lens element can have a cylindrical, concavely curved light entry surface and can spread the light out in a direction along a plane, let the light pass through without influencing it along a second plane oriented perpendicularly to the first plane, or spread it out at a different, smaller angle. To avoid repetitions, reference is made to FIGS. 5a to 5d of the applicant's post-published patent application referred to at the outset, and the passages of the description therein, which are hereby included in the content of the present patent application.

The lens element shown and described therein can also be used in the present case.

According to another advantageous embodiment of the invention, the lens element has a light entry surface that is rounded in a dome-like concave manner. This makes it possible to achieve a rotationally symmetrical light distribution of the luminaire using simple means.

According to another advantageous embodiment of the invention, the lens element has a light entry surface that is rounded in a cylindrically concave manner. As a result, using structurally simple means it is possible to provide a luminaire that has a non-rotationally symmetrical light distribution, e.g. an oval light distribution.

According to another advantageous embodiment of the invention, the cavity comprises a top wall that is opposite a central portion on a light exit surface of the collimator optics, the top wall forming, together with the central portion, a convergent lens, e.g. a biconvex or a planar-convex convergent lens. All the light fractions that hit the top wall starting from the LED are conducted from there to the central portion. The central portion thus focuses the light fractions.

According to another advantageous embodiment of the invention, a side wall of the cavity is surrounded by a total-reflection surface. In a first variant of the invention, the total-reflection surface is substantially shell-shaped. In an alternative embodiment of the invention, the total-reflection surface is formed in the manner of a Fresnel lens and divided into a plurality of total-reflection surface portions.

This makes it possible to obtain optimal light forwarding and light focusing.

According to another advantageous embodiment of the invention, the collimator optics is designed to focus light on a focal point or on a focal-point region. This makes it possible to obtain very high efficiency of the luminaire.

According to another advantageous embodiment of the invention, the lens element is arranged between the collimator optics and the focal point or the focal-point region. This makes it possible to provide a very efficient luminaire that is small, in particular is short in the axial direction.

According to another advantageous embodiment of the invention, the lens element has an external diameter that corresponds or substantially corresponds to an external diameter of the collimator optics and/or to an external diameter of the reflector. As a result, it is possible to provide a particularly simple construction of a luminaire according to the invention, in particular while taking account of the fact that it is consequently also possible to scale the luminaire for different sizes of the luminaire, e.g. even for different diameters of the housing, while retaining the same structure.

In addition, a particularly efficient luminaire can be provided by this design.

According to another advantageous embodiment of the invention, the lens element is arranged close to a light-exit opening in the housing. This enables a particularly small structure of the luminaire according to the invention.

According to another advantageous embodiment of the invention, the housing has an annular end face in the region of its light-exit opening. The light exit surface of the lens element can be arranged so as to be flush or almost flush with the annular end face, or arranged so as to be offset slightly inwards relative to the annular end face. It is thus possible to construct a luminaire that is axially very short.

According to another advantageous embodiment of the invention, a diffuser is arranged between the collimator optics and the lens element. Said diffuser can, for example, impose a slight diffusity on the light stream to prevent streak effects, and can make the light softer overall.

Other advantages of the invention emerge from the dependent claims that have not been mentioned and from the following description of the embodiment examples shown in the drawings, in which:

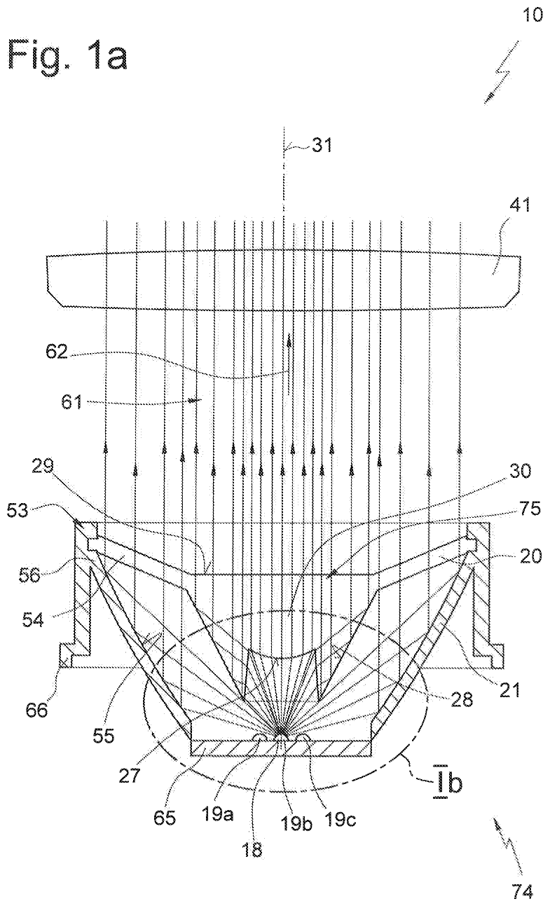

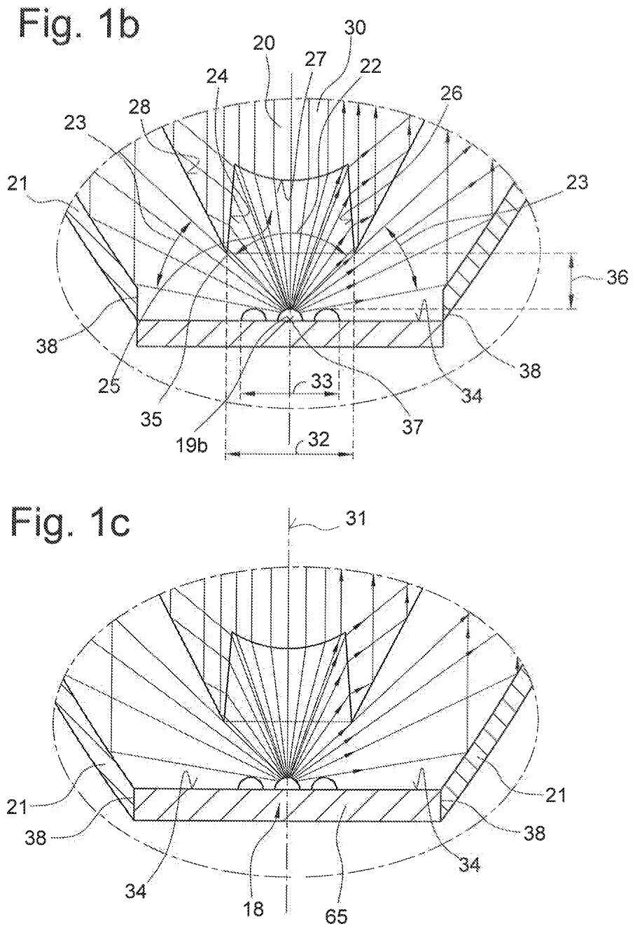

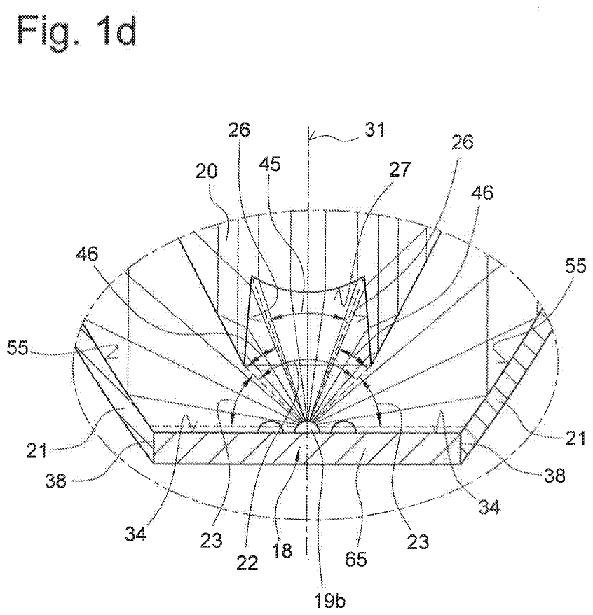

FIG. 1a is a schematic partially sectional view of a first embodiment example of a luminaire according to the invention, illustrating a light drive that has a light source, comprising three LEDs, as well as a collimator optics and a reflector, which generates a parallel pencil of light, and additionally indicating a diffuser,

FIG. 1b is an enlarged detailed view of the embodiment example of the luminaire of FIG. 1a according to the part-circle Ib in FIG. 1a, illustrating the different light fractions emitted by the middle LED of the light source,

FIG. 1c is a view according to FIG. 1b of a further embodiment example of a luminaire according to the invention, with the reflector reaching as far as to the arrangement plane of the LED,

FIG. 1d shows the embodiment example of FIG. 1c, with an additional explanation of the different light fractions,

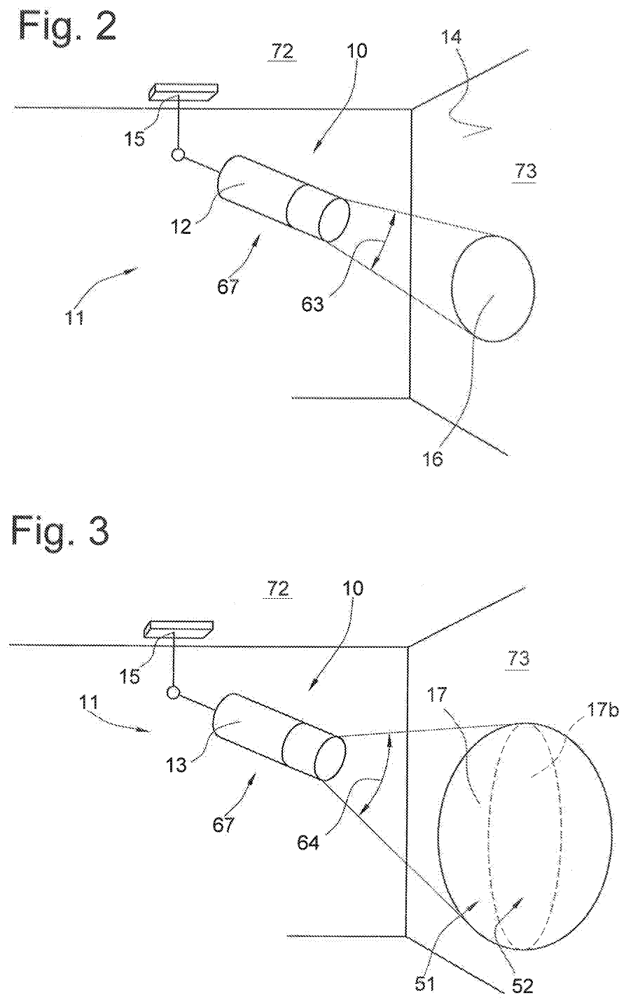

FIG. 2 shows a further embodiment example of a luminaire according to the invention, which is in the form of a lamp and arranged on a top wall of a housing, a first light distribution being generated on a side wall by the luminaire,

FIG. 3 is a view according to FIG. 2 of a further embodiment example of a luminaire according to the invention, by which a second and a third light distribution are generated,

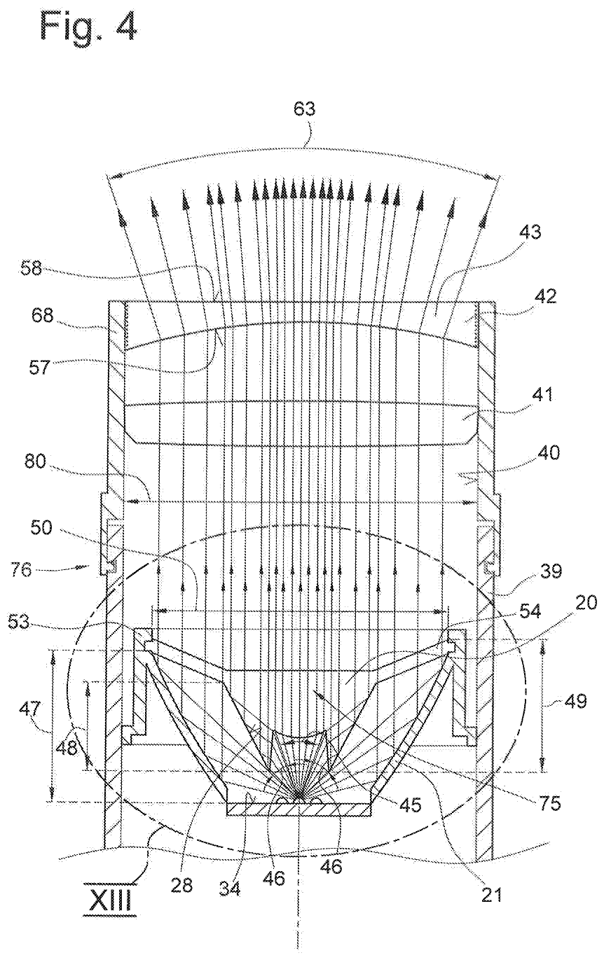

FIG. 4 is a schematic partially sectional outline view of a further embodiment example of a luminaire according to the invention using a light drive according to FIG. 1a, additionally showing a housing of the luminaire and a first divergent lens,

FIG. 5 is a view according to FIG. 4 of a further embodiment example of a luminaire according to the invention, showing a second divergent lens different from the first divergent lens,

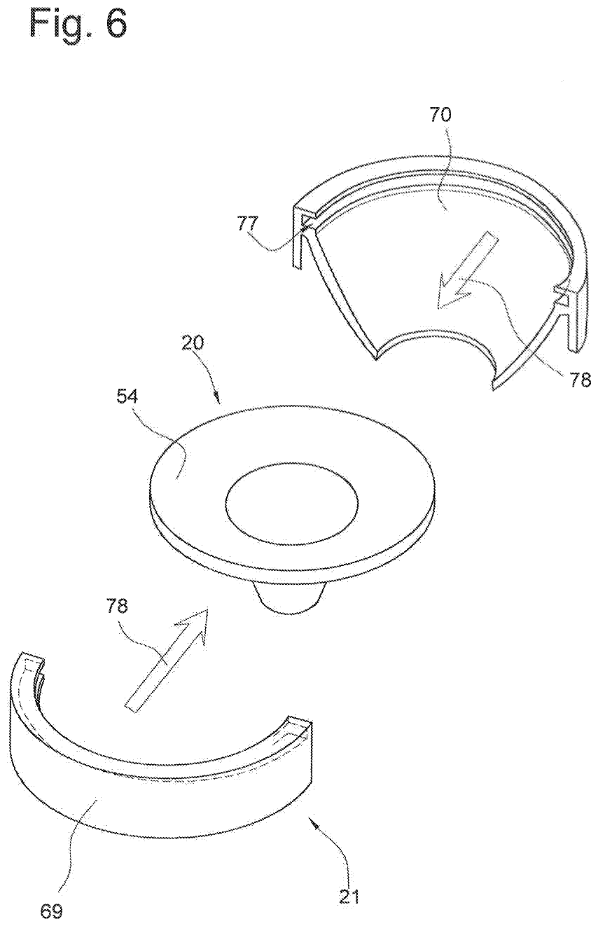

FIG. 6 is a schematic perspective detailed view of a reflector and a collimator optics of an embodiment example of a luminaire according to the invention, in which the reflector consists of two shell elements that can be fastened to one another in the radial direction and can hold the collimator optics between them,

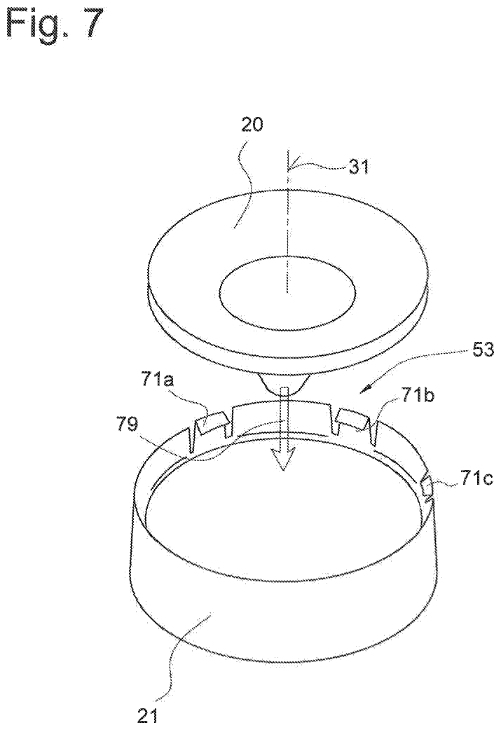

FIG. 7 is a schematic perspective detailed view of a reflector and a collimator optics of an embodiment example of a luminaire according to the invention, it being possible to fasten the collimator optics to the reflector as a result of an axial insertion movement by means of locking lugs,

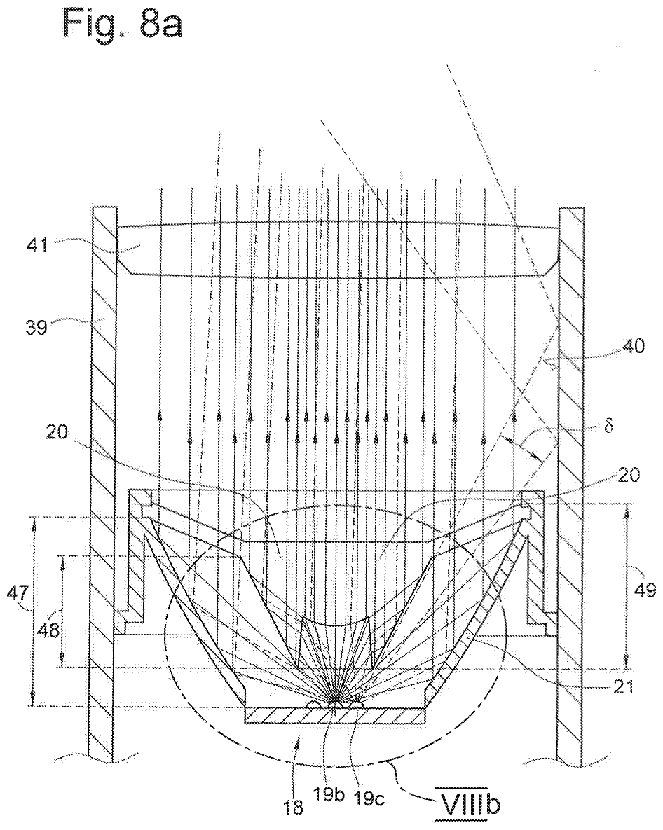

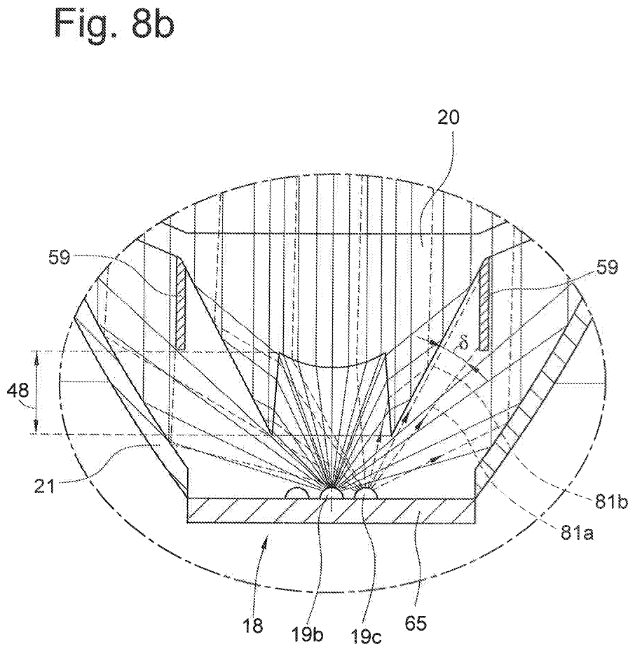

FIG. 8a is a view similar to FIG. 4 of a further embodiment example of a luminaire according to the invention but without the divergent lens and while illustrating a fundamentally undesirable light-beam fraction that has been emitted by the light source and hits the inner wall of the housing of the luminaire, where it is reflected, without having previously been reflected on a reflector and without having previously been influenced by optical boundary surfaces or total-reflection surfaces of the collimator optics,

FIG. 8b is an enlarged schematic partially sectional view according to FIG. 8a, for example according to part-circle VIIIb in FIG. 8a, of a further embodiment example, illustrating an additional aperture collar or a collar-like portion arranged on the collimator optics for preventing the above-described undesirable light fractions,

FIG. 9 is a view similar to the view in FIG. 8b of a further embodiment example of a luminaire according to the invention, having a collimator optics that has been altered compared with FIG. 8b and has a collar-like portion, which is in the form of a Fresnel lens and is likewise used for preventing undesirable light fractions,

FIG. 10 is a view similar to the view in FIG. 1a of a further embodiment example of a light drive according to the invention for use in a luminaire according to the invention, the light drive having a collimator and two reflectors arranged so as to be nested together,

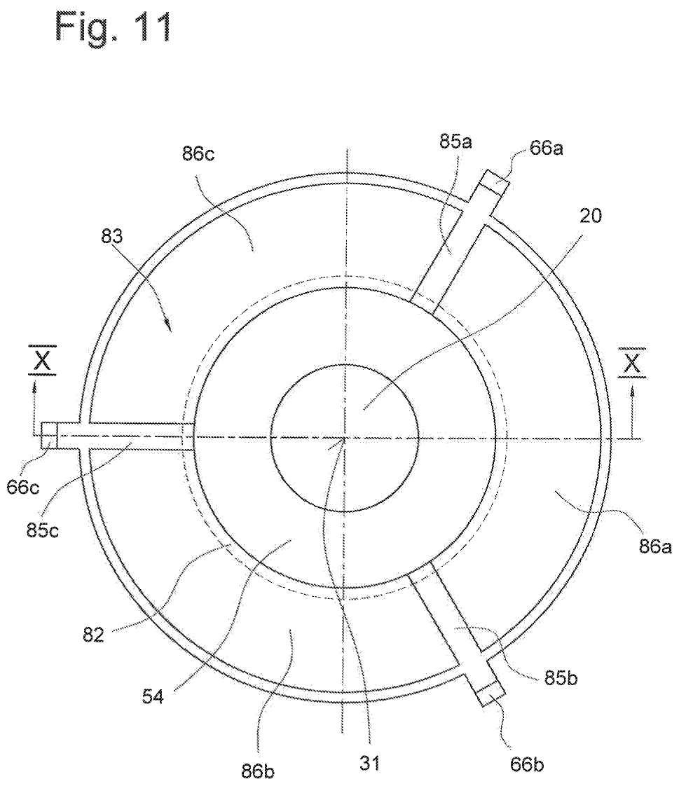

FIG. 11 is a schematic partially sectional plan view of the light drive of FIG. 10, for example along the viewing arrow XI in FIG. 10,

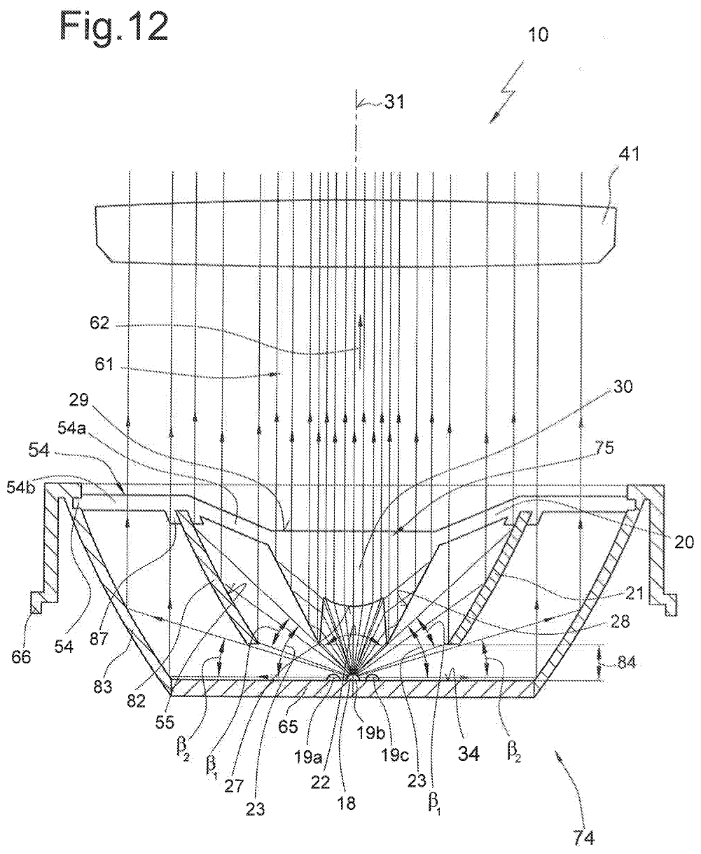

FIG. 12 is a view according to FIG. 10 of a further embodiment example of a light drive according to the invention for use in a luminaire according to the invention, the light drive likewise comprising two reflectors arranged so as to be nested together but which are fastened together in a different manner compared with FIG. 10,

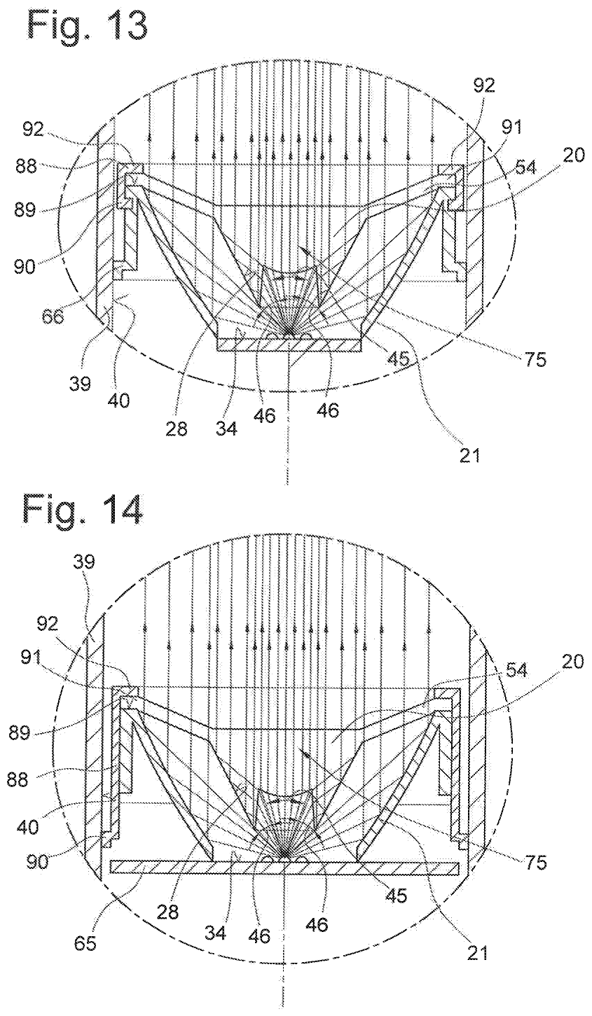

FIG. 13 is a schematic partially sectional enlarged view, for example along part-circle XIII in FIG. 4, of a further embodiment example of a luminaire according to the invention for illustrating a positioning of the collimator optics and the reflector relative to one another by means of a separate clamping ring, and

FIG. 14 is a view according to FIG. 13 of a further embodiment example of a luminaire according to the invention, illustrating a different clamping ring from that in the embodiment example according to FIG. 13.

Embodiment examples of the invention are described by way of example in the following description of the drawings, and with reference to the drawings. In the process, for the sake of clarity, identical or similar parts or elements or regions are denoted by the same reference numerals, in some cases with the addition of lowercase letters, in so far as it affects different embodiment examples.

Features that are described, shown or disclosed in relation to just one embodiment example can also be provided in any other embodiment example of the invention within the context of the invention. Embodiment examples altered in this way are also covered by the invention, even if they are not shown in the drawings.

All disclosed features are essential to the invention in their own right. The disclosure of the associated priority documents (copy of the previous application), of the cited documents and of the described prior-art devices is hereby incorporated in its entirety into the disclosure of the application, so as to also include one or more features of the subject matter disclosed therein into one or more claims of the present application. Altered embodiment examples of this kind are also covered by the invention, even if they are not shown in the drawings.

Embodiment examples of luminaires according to the invention are each denoted by 10 in the drawings.

FIG. 1a is a schematic perspective view of the main part of a luminaire 10 according to the invention, the so-called “light drive” 74, to illustrate the basic lighting principle. Said light drive comprises a light source 18, a collimator optics 20 and a reflector 21. The light drive generates a parallel pencil of light 61 or a substantially parallel pencil of light 61.

FIG. 1a additionally shows a diffuser 41. The precise basic lighting principle will be explained further below.

According to embodiment examples 4 and 5, a divergent lens 42 is also located downstream of the light drive 74 in the light path 62 in each case. In the process, a first divergent lens 43 according to FIG. 4 or a second divergent lens 44 according to FIG. 5 can be provided. The two divergent lenses 43 and 44 can differ from one another on account of the curvature of their light entry surface 57 and/or on account of the configuration of each light exit surface 58 in order to generate different light distributions.

In this way, a plurality of luminaires 12, 13 of the type according to the invention can provide a luminaire system 11 according to the invention. Said system will first be roughly explained on the basis of FIGS. 2 and 3:

FIGS. 2 and 3 are schematic perspective views of a first luminaire 12 (according to FIG. 2) and a second luminaire 13 (FIG. 3). The two luminaires 12, 13 form a luminaire system 11 according to the invention.

According to FIGS. 2 and 3, the luminaires are each used to illuminate a building space 14, in the form of a side wall 73 of a building room. The two luminaires 12, 13 are fastened to a top wall 72 of the building room in the region of an installation site 15. The tilt of said luminaires can, for example, be adjusted by means of a joint (only shown by way of indication).

A first light distribution 16 is cast on the building space 14 by means of the first luminaire 12, and a second light distribution 17 is cast on the building space by means of the second luminaire 13.

The first light distribution 16 and the second light distribution 17 are each rotationally symmetrical and indicate a circular area that is in particular homogeneously illuminated.

FIG. 3 also illustrates an alternative third light distribution 17b, which is shown in dashed lines in the form of an oval, i.e. non-rotationally symmetrical, light distribution.

The first light distribution 16 can be characterized by a first beam angle 63, and the second light distribution 17 can be characterized by a second, different beam angle 64.

The equivalents to the different beam angles 63, 64 can also be seen in the beam paths in FIGS. 4 and 5, the embodiment examples in FIGS. 4 and 5 obtaining different beam angles 63, 64 due to different curvatures of the light entry surface 57 of the relevant divergent lens 43, 44.

The luminaires 12, 13 according to the invention are formed as lamps 67 in accordance with the embodiment examples in FIGS. 2 and 3. However, the invention also covers a configuration in which the luminaire is formed as a surface-mounted ceiling luminaire or a recessed luminaire, or with a non-adjustable tilt.

In the following, the basic lighting principle of the light drive 74 will be explained in more detail on the basis of FIG. 1a and 1b:

As can be seen in FIGS. 1a and 1b, the light source 18 comprises a plurality of LEDs 19a, 19b, 19c. In each of the embodiment examples in FIGS. 1a and 1b, three LEDs 19a, 19b, 19c are shown. Any number of LEDs is possible, however. The light source 18 can comprise one LED but also a plurality of LEDs. If a plurality of LEDs are provided, they can be arranged substantially rotationally symmetrically, for example. For instance, FIG. 1a and 1b each show just three LEDs. However, each outer LED 19a, 19c can be arranged in a ring arrangement around the middle LED 19b, such that the light source 18 according to FIGS. 1a and 1b actually comprises two, three, four, five, six or more LEDs.

The LEDs are rigidly installed on a printed circuit board 65. The top of the printed circuit board defines an arrangement plane 34.

According to FIG. 1a, the light drive 74 comprises a collimator optics 20. This collimator optics comprises a central portion 75 and a positioning flange 54 that surrounds said central portion in an annular manner.

The central portion 75 has the optical boundary surfaces 27 and total-reflection surfaces 28 that contribute to the light focusing.

In the following, the central portion 75 of the collimator optics 20 will be described in detail:

As can be seen in FIG. 1b, the collimator optics 20 has a light entry surface 24 provided by a cavity 25.

The cavity has a top wall 27 and a circumferential side wall 26.

The top wall 27 is a component of a centrally arranged lens portion 30 of the collimator optics 20 and ensures that the light fractions hitting the top wall 27 are focused. In FIG. 4, these fractions are denoted by way of example by reference numeral 45 and are considered to be the central light beam 45.

The central light beam is surrounded by a surrounding light beam 46 (see FIG. 4). The surrounding light beam 46 comprises all the light fractions that hit the side-wall portions 26 of the cavity 25 starting from the light source 18. From here, they are first cast radially outwards, as best seen in FIG. 1b, and then hit total-reflection surfaces 28 of the collimator optics. These light fractions are likewise reflected by the total-reflection surfaces 28 towards the light exit surface 29 of the collimator optics 20 (see FIG. 1a).

Both the central light beam 45 and the light beam 46 surrounding it are collimated, as illustrated in particular in FIG. 1a, and leave the collimator optics as a parallel pencil of light 61.

Among other things, the special feature according to the invention is now that the light source 18 additionally emits a radially outer light fraction 23 (shown in FIG. 1b) that bypasses the collimator optics 20. The radially outer light fraction 23 hits a reflector 21, which has a reflection surface 55 on its inside. The reflection surface 55 is highly reflective or highly metallized.

The reflector 21 has a substantially parabolic shape. The light source 18 is arranged in the focal point 37 or in the focal-point region 37 of the reflector 21.

So that a radially outer light fraction 23 of the light fractions emitted by the light source 18 can actually bypass the collimator optics 20, the collimator optics 20 is arranged at a bypassing distance 36 from the light source 18 along the optical axis 31. This is shown in FIG. 1b.

The portion 35 of the collimator optics 20 closest to the light source 18, i.e. the lower free edge region 35 of the collimator optics, in which the side wall 26 of the cavity 25 meets the total-reflection surface 28, is arranged at said bypassing distance 36 from the light source 18 and/or from the arrangement plane 34.

This distance makes it possible to divide the light emitted by the light source 18 into a radially inner light fraction 22 and a radially outer light fraction 23 (FIG. 1b).

The radially inner light fraction 22 is captured in its entirety by the collimator optics 20. The radially inner light fraction comprises the central light beam 45, explained above in relation to FIG. 4, and the light beam 46 surrounding it.

The radially outer light fraction 23 bypasses the collimator optics 20 in its entirety and hits the reflection surface 55 of the reflector 21, where it is reflected. All, or almost all, the light that is emitted by the light source as the radially outer light fraction and bypasses the collimator optics 20 is thus captured by the reflector 21.

As a result, all, or almost all, the light emitted by the light source 18 can be used and utilized for further manipulation. A parallel pencil of light 61 having a very narrow light distribution is thus generated. In addition, the luminaire is also very efficient and makes use of all, or almost all, the light emitted by the light source 18.

In a direction transverse to the optical axis 31 of the light drive, the cavity 25 has a dimension denoted by 32, as is best seen in FIG. 1b. In the direction transverse to the optical axis 31, the dimension 32 is greater than the dimension 33 of the light source 18 in a direction transverse to the optical axis 31.

This configuration ensures that all, or almost all, the light 22 emanating from the light source 18 is captured by the collimator optics 20, apart from the radially outer light fractions 23.

To aid understanding, it should be noted that FIG. 1b, like the other figures, shows the light emission behavior of the light source 18 in a simplified manner, illustrated by a number of light beams.

For instance, FIG. 1b in particular shows only the light emitted by the middle LED 19b.

However, it is clear to the reader that corresponding light beams are also emitted by the two LEDS 19a, 19c.

The embodiment example in FIG. 1c substantially corresponds to the embodiment example in FIG. 1b, the sole difference being that the reflector 21 is still slightly closer to the arrangement plane 34. The portion 38 of the reflector 21 closest to the light source 18 is brought right up to the printed circuit board 65. As a result, light fractions emitted radially further to the outside can also be captured by the reflector 21.

On the basis of FIG. 1d, the different light fractions emitted by the light source 18 will be described and explained clearly:

The light source 18 emits radially inner light fractions 22 and radially outer light fractions 23.

The terms “radially on the inside” and “radially on the outside” are based on the optical axis 31 as a radial center.

The radially inner light fractions 22 comprise a central light beam 45 and a light beam 46 surrounding it.

The radially inner light fractions 22 are emitted along a beam angle of approximately 90°. When viewed in the plane of the paper in FIG. 1d, once the two 45° angular components shown therein to the left of the optical axis 31 and to the right of the optical axis 31, respectively, are added, the radially outer light fractions 23 extend at a total angle of almost 90°. It should be noted that the individual light sources may entail slight shadowing effects.

The central light beam 45 extends, for example, over an angle of 45°. The light beam 46 surrounding the central light beam 45 likewise extends in total over an overall angle of approximately 45°.

The size of the individual angles can vary within the context of the invention and depends on the dimensions and extension of the top surface 27 of the cavity 25 or the side-wall portions 26 of the cavity 25. In addition, it goes without saying that the size of the angles is also dependent on the distance between the collimator optics 20 and the light source 18.

The embodiment examples in FIG. 1a to 1d do not show any other components of the luminaire 10.

FIGS. 4 and 5 illustrate that the luminaire 10 according to the invention has a housing 39.

In numerous embodiment examples of the invention, this housing is circular-cylindrical.

As can be seen in FIGS. 4 and 5, each divergent lens 43, 44 can be secured on a housing cover 68, which can be releasably secured to the luminaire housing 39 by means of a mechanical interface 76.

The luminaire housing 39 and the housing cover 68 can have an inner circumferential surface that, for example, is kept black and matte to avoid any undesirable reflections and glare effects.

At this juncture, it should be noted that the divergent lenses 43 and 44 according to the embodiment examples in FIG. 5 can also be blackened on their outer peripheral surface, as indicated by a dotted line in FIGS. 4 and 5. The blackening serves to prevent light scatter and glare effects as a result of undesirable reflection. In this respect, reference is also made to German patent application DE 10 2019 119 682 A1 belonging to the applicant, which is included in full in the content of the present patent application so as to avoid repetitions and include one or more features of that post-published patent application in the application text or claims of the present patent application.

The embodiment examples in FIGS. 1a, 4 and 5 of the present patent application each show a diffuser 41 that can optionally be arranged in the beam path in order to provide blending and/or softening of the light. As a result, for example, undesirable streak effects can also be prevented.

In the embodiment examples in the drawings, the diffuser 41 is shown excessively far away from the light exit surface of the collimator optics 20. In actuality, the diffusers 41 can be closer to the light drive 74 in the large majority of embodiment examples.

The invention also covers a configuration where, in addition to a diffuser 41 of this kind or, alternatively, a diffuser 41, the light exit surface of the collimator 20 is designed in such a way that leads to a certain amount of light scatter or light mixing. For example, the light exit surface of the collimator 20 can be provided with a corresponding roughening or a microstructure.

Alternatively, only the light exit surface of the positioning flange 54 can be provided with an accordingly shaped surface, e.g. roughness.

In addition and/or alternatively, the light entry surface of the positioning flange 54, i.e. the side of the positioning flange 54 facing the arrangement surface 34, can also be provided with a roughening.

As can be seen from FIG. 1a, the reflector 21 has a highly metallized reflection surface 50. This reflection surface can, for example, be applied to a plastics injection-molded part. In particular, the plastics injection-molded part allows for particularly simple construction and manufacture of the reflector 21.

Alternatively, the reflector can also be made of aluminum or another suitable material.

As illustrated by way of example according to FIG. 1a, an installation portion 66 can advantageously be attached to the reflector 21. The installation portion 66 can be designed to secure the reflector 21 on the luminaire housing 39.

In particular, however, a fastening device 53 can also be arranged on the reflector 21. This fastening device can, for example, comprise a circumferential groove, as shown in FIG. 1. The fastening device 53 can be used to secure the collimator optics 20 on the reflector 21.

For this purpose, the collimator optics 20 can, for example, have a positioning flange 54 as indicated above.

This positioning flange is shown in particular in FIG. 1a. The positioning flange 54 extends radially outwards from the central portion 75 of the collimator optics 20.

As indicated by way of example in FIG. 6, the positioning portion can be inserted into a circumferential groove 77 in the reflector 21:

According to FIG. 6, the reflector 21 consists, for example, of a first reflector shell 69 and a second reflector shell 70. Said shells can be fastened to one another in the radial direction 78 and can grip the positioning flange 54 of the collimator optics on both sides and hold it between them.

Alternatively, as illustrated by way of example in FIG. 7, the collimator optics 20 and the reflector 21 can also be fastened in the axial direction 79, i.e. along the optical axis 31. For this purpose, a plurality of spring lugs 71a, 71b, 71c that axially secure the collimator optics 20 in the manner of snap-in hooks can be attached to the reflector 21.

By means of the fastening device 53, regardless of the configuration thereof, it is possible to obtain a relative fastening of the collimator optics 20 and reflector 21 to one another.

What is created as a result is a handling unit that ensures the collimator optics 20 and reflector 21 are positioned precisely relative to one another. Advantageously, precise positioning of said handling unit relative to the light source 18 can also be ensured.

As can be seen from the embodiment example in FIG. 4, the reflector 21 has an axial installation height 47 that exceeds the axial installation height 48 of the total-reflection surfaces 28 of the collimator optics 20. This makes it possible to configure the collimator optics 20 to have only a very small axial installation height 49.

In any case, the only thing that is crucial for the manufacture of the collimator optics 20, however, is the installation height of the central portion 75, which substantially corresponds to the installation height 48 of the total-reflection surfaces 28.

As a result of the accordingly provided combination of a collimator optics 20 with a reflector 21, the installation height 49 of the collimator optics 20 or the installation height 48 of the central portion 75 of the collimator optics can thus be retained even with large diameters 50, thereby simplifying the manufacture of the collimator optics 20.

According to FIG. 4, it is also clear that the external diameter 50 of the collimator optics is of such a size that it corresponds or substantially corresponds to the inner circumference 80 of the luminaire housing 39. As a result, all the light emitted by the light source 18 can be manipulated further.

In the embodiment examples in FIGS. 1a to 1c and 4 and 5, the fastening device 53, which allows the collimator optics 20 to be fastened to the reflector 21, is arranged in the region of the free end portion 56 of the reflector 21. However, the invention also covers a configuration in which the collimator optics 20 is fastened to the reflector 21 at a different site, e.g. closer to the portion 38 of the reflector 21 facing the light source 18.

In addition, the invention also covers a configuration in which the collimator optics 20 is secured directly relative to the luminaire housing 39, in particular independently of the reflector 21, or also, for example, secured directly rigidly relative to the arrangement surface 34.

For example, the invention also covers a configuration where the central portion 75 of the collimator optics 20 is rigidly secured relative to the printed circuit board 65 and the reflector 21 is rigidly secured relative to the luminaire housing 39 in the manner shown. In this embodiment example, the collimator optics 20 and reflector 21 are not directly interconnected. In this embodiment example, the positioning flange 54 of the collimator optics 20 can be omitted entirely.

According to the embodiment examples of the invention that are shown in the drawings, a substantially parallel pencil of light 61 exits the light drive 74. However, the invention also covers a configuration in which the pencil of light generated by the light drive 74 is either substantially parallel or not parallel.

The luminaire 10 according to the invention is used to generate a rotationally symmetrical light distribution 16, 17 or a non-rotationally symmetrical light distribution 17b.

The embodiment example in FIG. 8a corresponds to the view in FIG. 1a, but additionally showing a luminaire housing 39. In this case, a pencil of light that is undesirable per se is to be illustrated: The light fraction δ includes all the light fractions that are emitted by the LED 19c of the light source 18 according to FIG. 8a and hit the inner wall 40 of the luminaire housing 39, without having previously been reflected by the reflector 21 and without having previously passed through the collimator optics 20 and been refracted or fully reflected therein.

These light fractions δ are undesirable and can in particular generate glare effects due to their reflection out of the inner circumferential surface 40.

To eliminate these light fractions δ, one embodiment of the invention proposes a collar-like portion 59, which is shown in FIG. 8b. In this embodiment example, the collar-like portion is shown in hachure to aid clarity. However, said collar-like portion is in particular connected to the collimator optics 20 in one piece and in an integrally bonded manner, e.g. is molded thereto. The hachure is merely there to illustrate that the light beams (indicated by reference numerals 81a, 81b as marginal rays of the light fraction δ) cannot always pass through the collar-like portion unrefracted or unimpeded.

The embodiment example in FIG. 9 has the same purpose, i.e. to eliminate said undesirable light fractions δ: In this case, the collar-like portion 59 is provided by a Fresnel lens portion 60, which also captures these light fractions δ and makes them available for further manipulation by means of total reflection. This further increases the lighting efficiency of the luminaire.

On the basis of the embodiment examples in FIGS. 10 and 11, a further luminaire according to the invention will now be explained:

FIG. 10 shows a light drive 74 in a view similar to FIG. 1a.

Once again, the light drive 74 comprises a light source 18, having three LEDs 19a, 19b, 19c shown by way of example, and a collimator 20, which in this case is identical to the collimator 20 of the embodiment example in FIG. 1a.

The special feature of the embodiment example in FIG. 10 is that a first reflector 82 and a second reflector 83 are provided.

The two reflectors 82, 83 are arranged so as to be nested together. This in particular includes a configuration in which the two reflectors 82, 83 are arranged concentrically in relation to their respective optical axes 31.

The first reflector 82 is arranged at a reflector bypassing distance 84 from the arrangement surface 34 of the light source and/or from the light source 18.

The first reflector 82 is designed to capture, collect and collimate a pencil of light emitted by the light source 18 at the angle β1, i.e. a light fraction β1. In particular, this light is emitted as a parallel pencil of light after being reflected on the reflector 82.

The second reflector 83 is designed to capture and collimate a pencil of light emitted by the light source 18 at the space angle β2 and to emit it as a parallel or substantially parallel pencil of light.

In particular, this embodiment is particularly advantageous when particularly large luminaires, e.g. luminaires having an external diameter of e.g. more than 100 mm or more than 150 mm, are to be manufactured.

Small collimators 20 can still be used even with these large-dimension luminaires.

The collimator optics 20 captures and collimates the pencil of light 22 emitted radially on the inside.

At the same time, a radially outer emitted pencil of light 23 bypasses the collimator optics 20. The light-beam fractions 23 emitted radially outwards are divided into the light fractions β1 and β2, which reach the two reflectors 82, 83.

The collimator optics 20 can be fastened to the first reflector 82, in particular in the same way as the collimator 20 is fastened to the reflector 21 in the embodiment examples in FIGS. 1 to 9.

In the embodiment example in FIGS. 10 and 11, the second reflector 83 can additionally form a module together with the first reflector 82. For this purpose, for example, three connecting ribs 85a, 85b, 85c can be provided, which interconnect the two reflectors 82, 83. The light-beam fraction emitted at the space angle β2 can exit the second reflector 83 almost unimpeded due to the large free surfaces 86a, 86b, 86c and the only very narrow ribs 85a, 85b, 85c.

The invention also covers a configuration in which, alternatively, the first reflector 82 is fastened to the collimator optics 20 and the collimator optics 20 is directly fastened to the second reflector 83.

FIG. 12 shows an embodiment example of this kind: In this case, the first reflector 82 is inserted, by its upper edge region, into a corresponding retaining opening 87 in the positioning flange 54 of the collimator optics 20, where it is held. In the embodiment example in FIG. 12, the positioning flange 54 is divided into a first portion 54a and a second portion 54b.

In addition, the invention also covers embodiment examples in which the collimator optics and/or the first reflector 82 and/or the second reflector 83 are directly or indirectly rigidly secured relative to a housing of the luminaire (said housing not being shown in FIGS. 10, 11 and 12).

On the basis of the embodiment example in FIG. 13, an alternative way of securing the collimator optics 20 and reflector 21 relative to one another will now be explained:

FIG. 13 schematically indicates a clamping ring 88, which overlaps, by an overlap portion 92, an edge-side so-called “bearing portion” 91 of the collimator optics 20. The bearing portion 91 of the collimator optics 20 rests on the reflector 21 on a bearing surface 89.

The clamping ring 88 comprises a clamping-ring mount 90, by which the clamping ring 88 is secured on the reflector 21.

The clamping ring 88 is thus used to secure the collimator optics 20 relative to the reflector 21.

By way of example, the securing can be achieved by means of spring locks or spring-lug elements, or by means of an annular snap-in connection. However, auxiliary elements such as screws, clips, splints or the like can also be used alternatively or additionally.

The module comprising the reflector 21, the collimator optics 20 and the clamping ring 88 is secured on the inner wall 40 of the housing 39 by means of the installation portion 66, similarly to the above-described embodiment examples.

FIG. 14 shows a further alternative embodiment:

In this case, the clamping ring 88 is provided with a clamping-ring mount 90, which is used directly to secure the module, which comprises the collimator optics 20, the clamping ring 88 and the reflector 21, on the inner wall 40 of the luminaire housing 39.

In this case too, retaining lugs, spring-clamp elements or similar retaining elements (not shown in FIG. 14) can be provided.

Alternatively to the view in FIG. 14, in a further embodiment example the clamping ring 88 can also be directly secured on the printed circuit board 65, and a module comprising the clamping ring 88, the collimator optics 20, the reflector 21 and the printed circuit board 65 can be secured on the luminaire housing 39 by means of installation means (not shown in FIG. 14).

1-30. (canceled)

31. A luminaire for illuminating building spaces or building part-spaces, comprising a light source, which has at least one LED, as well as a collimator optics and a reflector, wherein a radially inner light fraction emitted by the light source hits the collimator optics and is focused thereby, and wherein a radially outer light fraction emitted by the light source bypasses the collimator optics, hits the reflector and is focused thereby.

32. The luminaire according to claim 31, wherein the collimator optics comprises a light entry surface provided by a cavity.

33. The luminaire according to claim 32, wherein, in a direction transverse to an optical axis of the collimator optics, the cavity has a dimension that exceeds a dimension of the light source.

34. The luminaire according to claim 31, wherein the collimator optics is arranged such that its portion closest to the light source is arranged at a bypassing distance from the light source along an optical axis of the collimator optics.

35. The luminaire according to claim 31, wherein the light source is arranged in a focal point of the reflector, which is parabolic or substantially parabolic.

36. The luminaire according to claim 31, wherein the reflector extends, by its portion facing the light source, as far as to, or as far as to the vicinity of, an arrangement plane of the light source.

37. The luminaire according to claim 31, wherein the reflector extends as far as to the vicinity of an inner wall of a housing of the luminaire.

38. The luminaire according to claim 31, wherein the radially inner light fraction can be divided into a central light beam and a light beam surrounding said central light beam, wherein the central light beam impinges on a lens portion of the collimator optics, and the surrounding light beam is focused by means of total-reflection surfaces.

39. The luminaire according to claim 31, wherein, in the direction of its optical axis, the reflector has an axial installation height that exceeds an axial installation height of total-reflection surfaces of the collimator optics.

40. The luminaire according to claim 31, wherein the collimator optics has a maximum external diameter that is greater than 30 mm, in particular greater than 35 mm, more particularly greater than 40 mm, more particularly greater than 45 mm, more particularly greater than 50 mm, more particularly greater than 55 mm, more particularly greater than 60 mm, more particularly greater than 70 mm, more particularly greater than 80 mm, more particularly greater than 90 mm, more particularly greater than 100 mm.

41. The luminaire according to claim 31, the luminaire provides a rotationally symmetrical light distribution.

42. The luminaire according to claim 31, wherein the collimator optics is fastened to the reflector.

43. The luminaire according to claim 31, wherein the collimator optics comprises a positioning flange.

44. The luminaire according to claim 43, wherein the collimator optics extends, by its positioning flange, as far as to the vicinity of an inner wall of the reflector in the region of its free end portion that is at a maximum distance from the light source.

45. The luminaire according to claim 43, wherein the radially outer light fraction passes through the positioning flange after being reflected on the reflector.

46. The luminaire according to claim 31, wherein the reflector is fastened to a housing of the luminaire.

47. The luminaire according to claim 31, wherein the luminaire comprises a lens element downstream of the collimator optics in the light path.

48. The luminaire according to claim 47, wherein the lens element is in the form of a divergent lens.

49. The luminaire according to claim 47, wherein the lens element comprises a concavely curved light entry surface and a planar or slightly convexly curved light exit surface .

50. A system for providing building luminaires , comprising a first luminaire and comprising a second luminaire, wherein each of the two luminaires comprises a light source, which has at least one LED, as well as a collimator optics and a reflector, wherein, in each case, a radially inner light fraction emitted by the light source hits the collimator optics and is focused thereby, and wherein, in each case, a radially outer light fraction emitted by the light source bypasses the collimator optics, hits the reflector and is focused thereby, and wherein a lens element is arranged on the side of the collimator optics facing away from the light source in the light path, wherein the first luminaire for providing a first light distribution has a first lens element, and wherein the second luminaire for providing a second light distribution that is different from the first light distribution has a second lens element.
